(19) United States
(12) Patent Application Publication
(10) Pub. No.: US 2024/0354809 A1
(43) Pub. Date: Oct. 24, 2024

(54) SYSTEMS AND METHODS TO AUTOMATE INCENTIVIZATION OF THEMED CONTENT GENERATED BY CONSUMER USERS

(71) Applicant: The Bounty App, Inc. (DBA Bounty), Miami, FL (US)

(72) Inventors: Aaron Robert Decker, Milford, OH (US); Marcus Shane Wood, Meadows of Dan, VA (US); Abraham Wolke, Miami, FL (US)

(21) Appl. No.: 18/303,319

(22) Filed: Apr. 19, 2023

(51) Int. Cl. G06Q 30/0273; G06Q 30/0208; G06Q 30/0241; G06Q 50/00

(52) U.S. Cl. CPC G06Q 30/0273; G06Q 30/0208; G06Q 30/0276; G06Q 50/01

(57) ABSTRACT

Systems and methods configured to automate incentivization of themed content generated by consumer users and shared through social online platforms are disclosed. Exemplary implementations may include: effectuating transmission of information to effectuate presentation of a function view within a user interface conveying a set of function parameters and exemplary rewards in accordance with an individual reward distribution function defining amounts of rewards as functions of values of one or more function parameters, the function parameter(s) may characterize interaction with and/or quality of content, the function view may include one or more fields facilitating entry and/or selection of one or more adjustments to the individual reward distribution function; receiving entry and/or selection of the adjustment(s); updating the individual reward distribution function in accordance with the adjustment(s); obtaining values of function parameters included in the set of function parameters; determining a reward; effectuating delivery of the reward; and updating the function view.

### FIELD OF THE DISCLOSURE

The present disclosure relates to automated incentivization of themed content generated by consumer users and shared through social online platforms.

### BACKGROUND

Websites that function as online stores for brands are known. Usage of social media platforms (e.g., Instagram, TikTok, etc.) for advertising is known. Payment to content creators for creating content for display on social media platforms is known.

### SUMMARY

This disclosure relates to automated incentivization of themed content generated by consumer users and shared through social online platforms. For example, amounts and/or values of rewards for generating and sharing themed content may be determined automatically based on characteristics of the content creator and content generated by the content creator. Some brands may find value in content creators creating promotional content for the brands. A brand may encourage a content creator to create promotional content by rewarding the content creator (e.g., with monetary rewards, with brand products, etc.). Normally, the process of identifying a content creator, negotiating terms of a creator/brand relationship, administering terms of a creator/brand relationship, and/or other aspects of having content creators generate themed content are administered in a “one off” manner through interpersonal communication and manual administration. Manually rewarding content creators may only facilitate incentivization of the generation and/or sharing of themed content by a relatively limited set of content creators (e.g., those manually identified by individual members of the brand to be rewarded for promotions, and/or others). Automating the incentivization process for themed content may result in enhanced effectiveness and/or efficiency of online social platforms for brands that utilize themed, user-generated, content, and/or provide other advantages.

One aspect of the present disclosure relates to a system configured to automate incentivization of themed content generated by consumer users and shared through social online platforms. The system may include storage media, one or more servers, one or more client computing platforms, and/or other components.

The storage media may be configured to store information organized into client records. Individual client records may include individual reward distribution functions. Individual reward distribution functions may define amounts of rewards as functions of values of one or more function parameters. Function parameters may characterize interaction with content and/or quality of content.

The one or more servers may include one or more hardware processors configured by machine-readable instructions, and/or other components. The processor(s) may be configured to effectuate transmission of information included in an individual client record to a client computing platform. In some implementations, transmission of the information may effectuate presentation of a function view within a user interface on the client computing platform. The function view may convey information about a reward distribution function. The reward distribution function may define reward amount for a given user as a function of interaction with themed content generate and shared by the given user on one or more online platforms. An individual reward distribution function included in the individual client record may define amounts of rewards as a function of values of function parameters included in the set of function parameters. The function view may include one or more fields that facilitate entry and/or selection of one or more adjustments to the individual reward distribution function. The processor(s) may be configured to receive entry and/or selection of the one or more adjustments to the individual reward distribution function. The processor(s) may be configured to update the individual reward distribution function included in the client record in accordance with the one or more adjustments to the individual reward distribution function.

The processor(s) may be configured to obtain values of function parameters included in the set of function parameters. The values of function parameters may be associated with an individual content creator by virtue of characterizing interaction with and/or quality of content generated by the individual content creator. The processor(s) may be configured to determine a reward to be awarded to the individual content creator responsive to obtaining the values of the function parameters. In some implementations, determining the reward may include evaluating the individual reward distribution function in accordance with the values of the function parameters included in the set of function parameters to determine an amount of rewards. In some implementations, the reward may be determined in accordance with the amount of rewards. The processor(s) may be configured to effectuate delivery of the reward to the individual content creator. The processor(s) may be configured to update the function view on the client computing platform to convey the delivery of the reward, responsive to delivery of the reward.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured to automate incentivization of themed content generated by consumer users and shared through social online platforms, in accordance with one or more implementations.

FIGS. 2A, 2B, 2C, and 2D illustrate a method of automating incentivization of themed content generated by consumer users and shared through social online platforms, in accordance with one or more implementations.

FIG. 3 illustrates a post published on a social media platform, in accordance with one or more implementations.

FIG. 4 illustrates a function view presented on a client computing platform, in accordance with one or more implementations.

### DETAILED DESCRIPTION

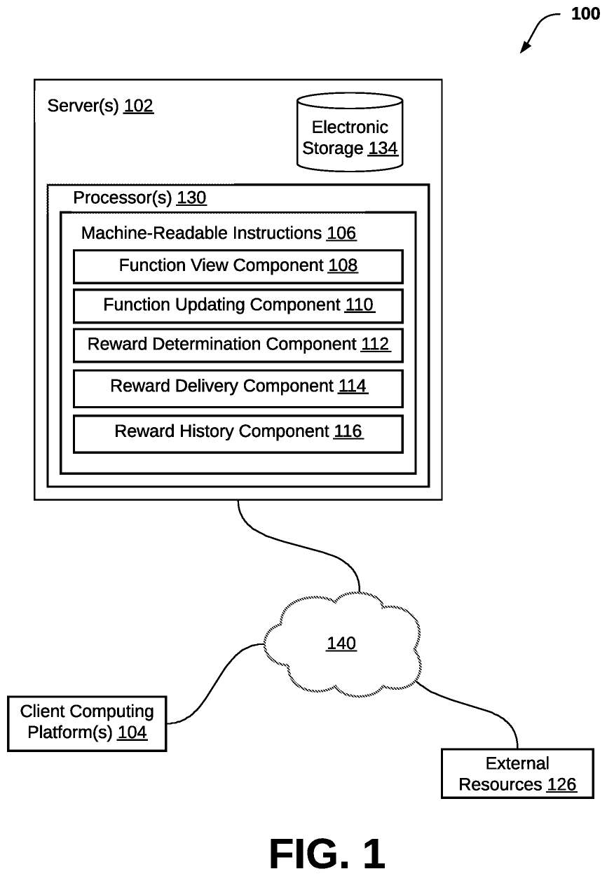

FIG. 1 illustrates a system 100 configured to automate incentivization of themed content generated by consumer users and shared through social online platforms, in accordance with one or more implementations. In some implementations, system 100 may include one or more servers 102. Server(s) 102 may be configured to communicate with one or more client computing platforms 104 according to a client/server architecture, a peer-to-peer architecture, and/or other architectures. Client computing platform(s) 104 may be configured to communicate with other client computing platforms via server(s) 102 and/or according to a client/server architecture, a peer-to-peer architecture, and/or other architectures. Users may access system 100 via client computing platform(s) 104.

Server(s) 102 may be configured by machine-readable instructions 106. Machine-readable instructions 106 may include one or more instruction components. The instruction components may include computer program components. The instruction components may include one or more of function view component 108, function updating component 110, reward determination component 112, reward delivery component 114, reward history component 116, and/or other instruction components.

In some implementations, system 100 may include non-transitory electronic storage 134. Non-transitory electronic storage 134 may be configured to store information organized into client records.

Function view component 108 may be configured to effectuate transmission of information included in an individual client record to a given client computing platform 104. The individual client record may be associated with an individual client. The individual client record may include an individual reward distribution function. Individual reward distribution functions may define amounts of rewards as functions of values of one or more function parameters. In some implementations, the one or more function parameters may be included in a set of function parameters. By way of non-limiting example, individual reward distribution functions may be mathematical functions. Individual reward distribution functions may be one or more of continuous, discrete, linear, nonlinear, piecewise, and/or another type of function.

As used herein, any reference to “amount” may be used to describe an amount, a number, a monetary value, a value, and/or any combination thereof. As used herein, any reference to “reward” may be used to describe payment, compensation, gift, bonus, prize, consideration, and/or any combination thereof. By way of non-limiting example, a reward may include money, a good, a product, a service, another reward, and/or any combination thereof.

Function parameters may characterize interaction with content and/or quality of content. By way of non-limiting example, the set of function parameters may include one or more of content creator activity information, interaction information, a minimum rate of reward, a maximum rate of reward, a maximum reward, a weight of an individual value included in the content creator activity information, a weight of an individual value included in the interaction information, and/or other parameters. The content creator activity information may characterize content generated by an individual content creator. In some implementations, the content may include a post on a social media platform, a photo, a video, an audio recording, and/or another media form. In some implementations, a post on a social media platform may include a video, one or more images, an audio recording, a caption, and/or another media form. The interaction information may include one or more of a number of viewers of the content, a number of views of the content, a number of comments on the content, a number of reactions to the content, and/or other information. In some implementations, a reaction may demonstrate an individual user liking, loving, laughing at, being sad about, being surprised by, and/or demonstrating other emotions regarding the post. The weight of an individual value may characterize magnitude of effect of the individual value on evaluation of the individual reward distribution function. By way of non-limiting example, a weight of an individual value being zero may characterize that the individual value has no effect on evaluation of the individual reward distribution function.

In some implementations, the set of function parameters may include a maximum cumulative amount and/or cumulative value of rewards awarded to one or more content creators over a given period of time. In some implementations, individual client records may include historical reward information. The historical reward information may include a cumulative amount and/or value of rewards awarded to one or more content creators over a given period of time. In some implementations, the set of function parameters may include a minimum reward. The minimum reward may define a minimum reward a content creator will receive. By way of non-limiting example, the content creator may only be eligible to receive the minimum reward given the content creator satisfies one or more requirements.

Transmission of the information may effectuate presentation of a function view within a user interface on the given client computing platform 104. In some implementations, the function view may convey a set of function parameters and exemplary rewards in accordance with an individual reward distribution function. The individual reward distribution function included in the individual client record may define amounts of rewards as a function of values of function parameters included in the set of function parameters. In some implementations, the exemplary rewards may be determined using the individual reward distribution function in accordance with exemplary values of function parameters included in the set of function parameters. The function view may include one or more fields that facilitate entry and/or selection of one or more adjustments to the individual reward distribution function. By way of non-limiting example, the one or more adjustments to the individual reward distribution function may include one or more of one or more adjustments to the set of function parameters and/or one or more adjustments to weight(s) of individual function parameters included in the set of function parameters. An adjustment to the set of function parameters may include and addition and/or a removal of one or more function parameters from the set of function parameters.

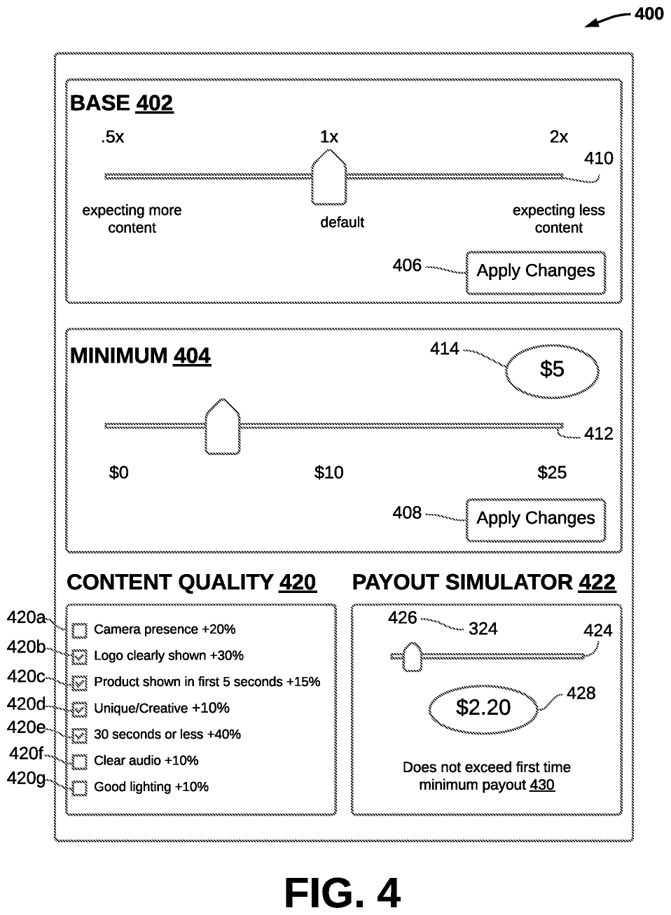

FIG. 4 illustrates an exemplary function view 400 presented on a client computing platform. Function view 400 may include a base element 402, a minimum element 404, and a content quality element 420. Base element 402, minimum element 404, and content quality element 420 may convey function parameters included in a set of function parameters for an individual reward distribution function. By way of non-limiting example, base element 402 may convey a base function parameter. A value of the base function parameter may scale an amount of rewards determined by a default reward distribution function. Base element 402 may include slider 410. Slider 410 may enable entry and/or selection of an adjustment to the base function parameter. By way of non-limiting example, minimum element 404 may convey a minimum function parameter. By way of non-limiting example, a value of the minimum function parameter may be a minimum reward for first-time content creators. Minimum element 404 may include slider 412. Slider 412 may enable entry and/or selection of an adjustment to the minimum reward. Base element 402 and minimum element 404 may include user interface elements 406 and 408, respectively. User interface elements 406 and 408 may be buttons enabling a client to confirm adjustments to one or more function parameters.

Content quality element 420 may include quality metric selectors 420a-420g for individual quality metrics. Quality metric selectors 420a-420g may include checkboxes enabling adjustments to one or more of the quality metrics. By way of non-limiting example, selection of a checkbox included in an individual one of quality metric selectors 420a-420g may denote selection of the individual one of quality metric selectors 420a-420g. Selection of an individual one of quality metric selectors 420a-420g may effectuate inclusion of an individual quality metric in the set of function parameters and/or inclusion or modification an individual weight in the set of function parameters. By way of non-limiting example, quality metric selector 420c may have been selected by virtue of the checkbox being checked. Selection of quality metric selector 420c may effectuate inclusion of a quality metric of a product being shown in the first five seconds of content and/or inclusion or setting of a weight of 15% for the quality metric in the set of function parameters. Unselecting an individual one of quality metric selectors 420a-420g (e.g., by removing a check from a checkbox) may effectuate removal from the set of function parameters or setting of a weight for an individual quality metric to zero. By way of non-limiting example, quality metric selector 420a may be unselected. Unselecting quality metric selector 420a may effectuate removal of a quality metric of “camera presence” from the set of function parameters or assignment of a weight of the quality metric to zero.

Function view 400 may include payout simulator 422. Payout simulator 422 may convey exemplary rewards in accordance with the individual reward distribution function. Payout simulator may include reference 426, slider 424, exemplary reward 428, and notification 430. Reference 426 and slider 424 may be denote and select, respectively, an exemplary number of views for content. By way of non-limiting example an exemplary number of views may be an exemplary value of a function parameter. Exemplary reward 428 may denote an exemplary reward determined by the individual reward distribution function in accordance with the exemplary number of views denoted by reference 426 and/or one or more exemplary values of other function parameters. The depiction of function view 400 is merely exemplary and is not intended to be limiting.

Referring back to FIG. 1, function updating component 110 may be configured to receive entry and/or selection of the one or more adjustments to the individual reward distribution function. Function updating component 110 may be configured to update the individual reward distribution function included in the client record in accordance with the one or more adjustments to the individual reward distribution function. Updating the individual reward distribution function may include updating the function view to reflect the one or more adjustments entered and/or selected. In some implementations, updating the function view may include reflecting the one or more adjustments and/or updating the exemplary rewards in accordance with the updated reward distribution function.

Reward determination component 112 may be configured to obtain values of function parameters included in the set of function parameters. The values of function parameters may be associated with an individual content creator by virtue of characterizing interaction with and/or quality of content generated by the individual content creator.

Obtaining the values of function parameters may include obtaining values of quality metrics. In some implementations, obtaining one or values of one or more quality metrics may include automatically analyzing content to generate the values of the quality metrics. By way of non-limiting example, automatically analyzing the content may include one or more of automatically analyzing a video, an image, audio, and/or other components of the content. In some implementations, analyzing the content may include analyzing a caption included in the content. The quality metrics may include one or more of timeframe of presence of an object and/or a person within the content, quality of framing of an object and/or a person within the content, duration of the content, audio quality of the content, visual quality of the content, similarity of the content to other content, and/or other metrics. In some implementations, presence of an object and/or a person may include the object and/or the person being visible within the content. In some implementations, the object may include a logo associated with the individual client. By way of non-limiting example, the individual client may be a brand offering products. The products may include the object. For example, the object may include a logo associated with the brand. In some implementations, presence of the object may include the logo being visible within the content. By way of non-limiting example, quality of framing of an object and/or a person within the content may characterize how centered the object and/or the person is within an image and/or a timeframe of a video during which the object and/or the person are within a centered section of the video. In some implementations, quality of framing of an object may characterize whether a logo associated with the individual client is visible within the content. For example, quality of framing of an object may be higher for videos in which the logo is visible.

In some implementations, visual quality of the content may include proper lighting, resolution, and/or other visual properties of an image and/or a video. In some implementations, audio quality of the content may include audio content, volume, clarity, and/or other audio properties of a video. In some implementations, values of quality metrics denoting high quality characteristics of the content may result in the individual reward distribution function determining higher amounts of rewards. By way of non-limiting example, the amounts of rewards may be higher in proportion to a weight of the quality metrics in the set of function parameters.

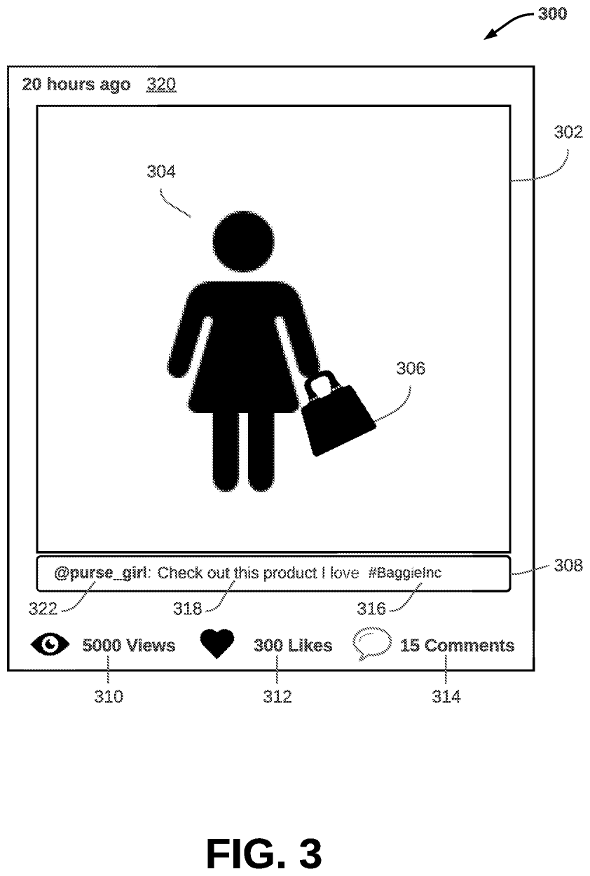

FIG. 3 illustrates a post 300 published on a social media platform. Post 300 may be content generated by a content creator. Post 300 may include and/or display a video 302, a caption 308, a number of views 310, a number of likes 312, a number of comments 314, and a duration of time 320. Video 302 may depict a content creator 304 of the social media platform and a product 306. By way of non-limiting example, values of one or more quality metrics may be obtained for video 302. For example, a value characterizing good framing of creator 304 and product 306 may be obtained by virtue of content creator 304 and product 306 being centered within video 302. By way of non-limiting example, video 302 may include audio of content creator 304 describing product 306. Caption 308 may include a username 322 of the user on the social media platform, a comment 318, and a hashtag 316. By way of non-limiting example, caption 308 may be analyzed to determine presence of hashtag 316 and/or another hashtag. In some implementations, the presence of particular hashtags may be included in the set of function parameters and/or affect determination of amounts of rewards. Comment 318 may promote product 306 and/or describe video 302. Hashtag 316 may reference a brand providing product 306.

Number of views 310 may depict the number of times video 302 has been viewed since post 300 was published. Number of likes 312 may depict the number of users of the social media platform who reacted to post 300 with a like since post 300 was published. Number of comments 314 may depict the number of comments users of the social media platform have published in response to post 300. One or more of number of views 310, number of likes 312, and/or number of comments 314 may characterize interaction with the content generated by the content creator. One or more of number of views 310, number of likes 312, and/or number of comments 314 may be included in the set of function parameters.

Returning to FIG. 1, reward determination component 112 may be configured to determine a reward to be awarded to the individual content creator responsive to obtaining the values of the function parameters. In some implementations, determining the reward may include evaluating the individual reward distribution function in accordance with the values of the function parameters included in the set of function parameters. The reward may be determined in accordance with the amount of awards. By way of non-limiting example, evaluating the reward distribution function in accordance with the values of the function parameters included in the set of function parameters may denote a numerical value representing an amount of awards. By way of non-limiting example, the reward may be determined to be an amount of money corresponding to the amount of the awards.

Reward delivery component 114 may be configured to effectuate delivery of the reward to the individual content creator. Responsive to delivery of the reward, reward delivery component 114 may be configured to update the function view on the given client computing platform 104 to convey the delivery of the reward. In some implementations, historical reward information may be updated responsive to delivery of the reward. By way of non-limiting example, the function view may be updated to reflect updated historical reward information. For example, the function view may be updated to convey a percentage of a budget for rewarding one or more content creators has been used over a given period of time. For example, the function view may be updated to convey an amount of rewards that have been delivered to one or more content creators over a given period of time.

Reward history component 116 may be configured to obtain historical reward information included in the individual client record. Reward history component 116 may be configured to determine whether a maximum cumulative amount and/or value of rewards awarded to one or more content creators over a given period of time has been approached and/or reached in accordance with the historical reward information.

Function updating component 110 may be configured to update the individual reward distribution function included in the individual client record responsive to determining that the maximum cumulative amount and/or value of rewards has been neared. By way of non-limiting example, the individual reward distribution function may be updated such that the values and/or amounts of rewards determined using the individual reward distribution function are lowered. By way of non-limiting example, the values and/or amounts of rewards determined using the individual reward distribution function as updated may be 0%, 10%, 25%, 50%, 75%, and/or another percentage of the value and/or amounts determined using the reward distribution function prior to updating. In some implementations, responsive to determining the maximum cumulative amount and/or value of rewards has been approached, content creators may be unable to create content in exchange for a reward. In some implementations, an individual content creator may be awarded after determination of the maximum cumulative amount and/or value of rewards being approached. In some implementations, the individual content creator may only be awarded given content generated by the individual content creator was produced prior to the determination.

Reward determination component 112 may be configured to determine, in accordance with the content creator activity information, whether the individual content creator is eligible for a minimum reward. By way of non-limiting example, the individual content creator may be eligible for a minimum reward by virtue of posting content related to an individual client for a first time. By way of non-limiting example, an individual client may only be eligible for the minimum reward once. Reward determination component 112 may be configured to determine the individual content creator is eligible for a minimum reward. Reward determination component 112 may be configured to determine whether the reward to be awarded to the individual content creator is less than the minimum reward. In some implementations, determining the reward is less than the minimum reward may include determining that a value and/or an amount of the reward is less than a value and/or an amount of the minimum reward.

Reward delivery component 114 may be configured to effectuate delivery of the minimum reward, responsive to determining the reward is less than the minimum reward. In some implementations, delivery of the minimum reward may be effectuated alternatively to delivery of the reward to be awarded to the individual content creator being effectuated.

Reward determination component 112 may be configured to determine whether the individual content creator is eligible for one or more other rewards. The other rewards may include rewards not determined using the individual reward distribution function. In some implementations, one or more of the other rewards may be one or more bonuses awarded to the individual content creator. By way of non-limiting example, the individual content creator may be eligible for the one or more rewards for one or more of a given time period passing (e.g., a holiday), content generated by the content creator achieving a given level of interaction, manual selection by the individual client, and/or another reason. In some implementations, reward determination component 112 may be configured to determine the individual content creator is eligible for one or more other rewards. Determining the individual content creator is eligible for one or more other rewards may include determining for individual ones of the one or more other rewards the individual content creator is eligible.

Reward delivery component 114 may be configured to effectuate delivery of the one or more other rewards responsive to determining the individual content creator is eligible for the one or more other rewards. In some implementations, effectuation of delivery of the one or more other rewards may be in addition to effectuation of delivery of the reward to be awarded to the individual content creator.

In some implementations, server(s) 102, client computing platform(s) 104, and/or external resources 126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 126 may be operatively linked via some other communication media.

A given client computing platform 104 may include one or more processors configured to execute computer program components. The computer program components may be configured to enable an expert or user associated with the given client computing platform 104 to interface with system 100 and/or external resources 126, and/or provide other functionality attributed herein to client computing platform(s) 104. By way of non-limiting example, a given client computing platform 104 and/or a given server 102 may include one or more of a server, a desktop computer, a laptop computer, a handheld computer, a tablet computing platform, a NetBook, a Smartphone, a gaming console, and/or other computing platforms.

External resources 126 may include sources of information outside of system 100, external entities participating with system 100, and/or other resources. In some implementations, some or all of the functionality attributed herein to external resources 126 may be provided by resources included in system 100.

Server(s) 102 may include electronic storage 134, one or more processors 130, and/or other components. Server(s) 102 may include communication lines, or ports to enable the exchange of information within a network and/or other servers. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 134 may comprise non-transitory storage media that electronically stores information. The electronic storage media of electronic storage 134 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 134 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 134 may include one or more virtual storage resources (e.g., cloud storage, a virtual private network, and/or other virtual storage resources). Electronic storage 134 may store software algorithms, information determined by processor(s) 130, information received from server(s) 102, information received from client computing platform(s) 104, and/or other information that enables server(s) 102 to function as described herein.

Processor(s) 130 may be configured to provide information processing capabilities in server(s) 102. As such, processor(s) 130 may include one or more of a digital processor, an analog processor, a digital circuit designed to process information, an analog circuit designed to process information, a state machine, and/or other mechanisms for electronically processing information. Although processor(s) 130 is shown in FIG. 1 as a single entity, this is for illustrative purposes only. In some implementations, processor(s) 130 may include a plurality of processing units. These processing units may be physically located within the same device, or processor(s) 130 may represent processing functionality of a plurality of devices operating in coordination. Processor(s) 130 may be configured to execute components 108, 110, 112, 114, 116, and/or other components. Processor(s) 130 may be configured to execute components 108, 110, 112, 114, 116, and/or other components by software; hardware; firmware; some combination of software, hardware, and/or firmware; and/or other mechanisms for configuring processing capabilities on processor(s) 130. As used herein, the term “component” may refer to any component or set of components that perform the functionality attributed to the component. This may include one or more physical processors during execution of processor readable instructions, the processor readable instructions, circuitry, hardware, storage media, or any other components.

It should be appreciated that although components 108, 110, 112, 114, and/or 116 are illustrated in FIG. 1 as being implemented within a single processing unit, in implementations in which processor(s) 130 includes multiple processing units, one or more of components 108, 110, 112, 114, and/or 116 may be implemented remotely from the other components. The description of the functionality provided by the different components 108, 110, 112, 114, and/or 116 described below is for illustrative purposes, and is not intended to be limiting, as any of components 108, 110, 112, 114, and/or 116 may provide more or less functionality than is described. For example, one or more of components 108, 110, 112, 114, and/or 116 may be eliminated, and some or all of its functionality may be provided by other ones of components 108, 110, 112, 114, and/or 116. As another example, processor(s) 130 may be configured to execute one or more additional components that may perform some or all of the functionality attributed below to one of components 108, 110, 112, 114, and/or 116.

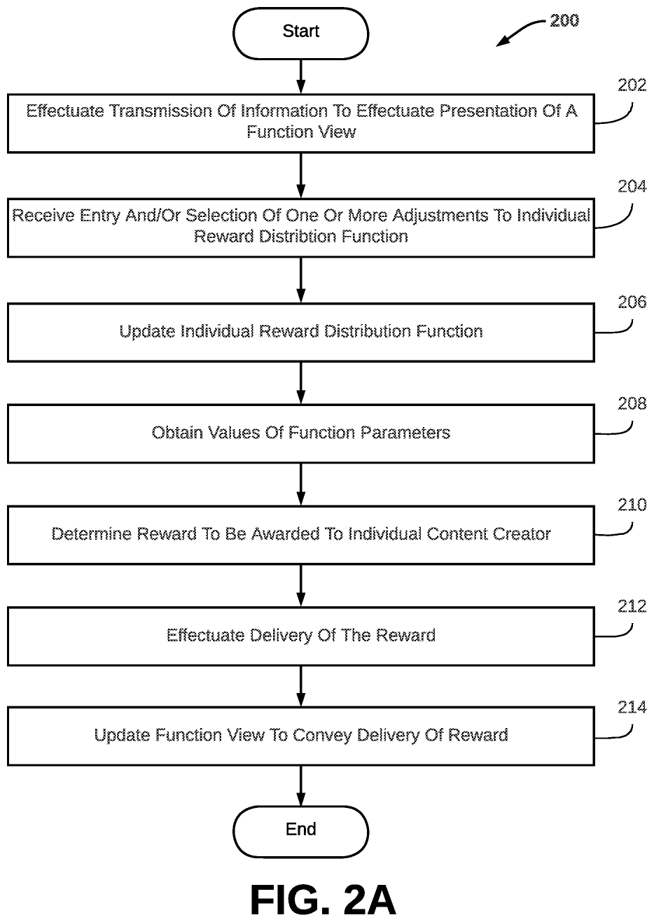

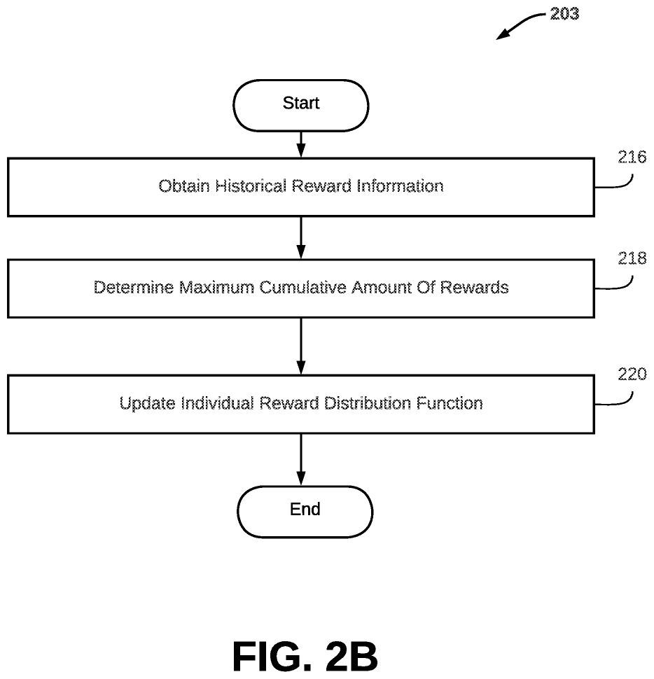

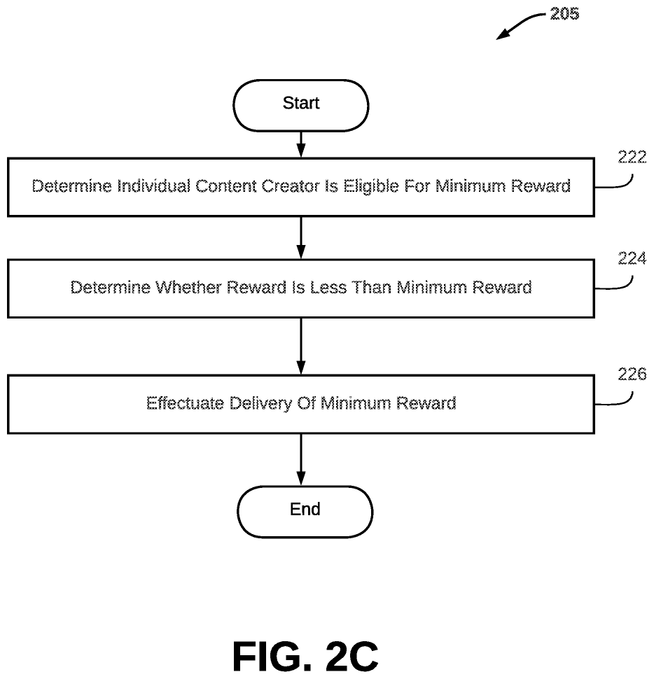

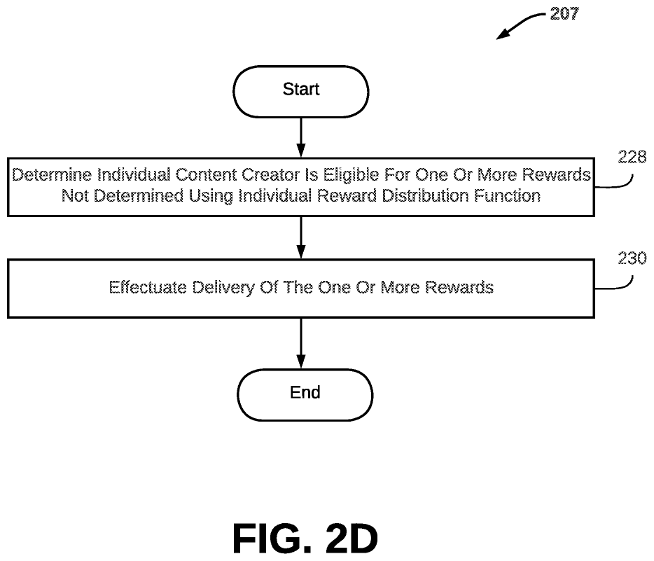

FIGS. 2A, 2B, 2C, and 2D illustrate methods 200, 203, 205, and 207 (respectively) for automating incentivization of themed content generated by consumer users and shared through social online platforms. The operations of methods 200, 203, 205, and 207 presented below are intended to be illustrative. In some implementations, methods 200, 203, 205, and 207 may be accomplished with one or more additional operations not described, and/or without one or more of the operations discussed. Additionally, the order in which the operations of methods 200 illustrated in FIG. 2A, the operations of method 203 illustrated in FIG. 2B, the operations of method 205 illustrated in FIG. 2C, and the operations of method 207 illustrated in FIG. 2D described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200. FIG. 2A illustrates method 200, in accordance with one or more implementations.

An operation 202 may include effectuating transmission of information included in an individual client record to a client computing platform to effectuate presentation of a function view within a user interface on the client computing platform. The individual client record may be associated with an individual client. The individual client record may include an individual reward distribution function. The individual reward distribution function may define an amount of rewards as a function of values of one or more function parameters. Function parameters may characterize interaction with content and/or quality of content. The function view may convey a set of function parameters and exemplary rewards in accordance with the individual reward distribution function. The exemplary rewards are determined using the individual reward distribution function in accordance with exemplary values of function parameters included in the set of function parameters. The function view may include one or more fields that facilitate entry and/or selection of one or more adjustments to the individual reward distribution function. Operation 202 may be performed by one or more hardware processors configured by machine-readable instructions including a component that is the same as or similar to function view component 108, in accordance with one or more implementations.

An operation 204 may include receiving entry and/or selection of the one or more adjustments to the individual reward distribution function. Operation 204 may be performed by one or more hardware processors configured by machine-readable instructions including a component that is the same as or similar to function updating component 110, in accordance with one or more implementations.

An operation 206 may include updating the individual reward distribution function included in the client record in accordance with one or more adjustments to the individual reward distribution function. Operation 206 may be performed by one or more hardware processors configured by machine-readable instructions including a component that is the same as or similar to function updating component 110, in accordance with one or more implementations.

An operation 208 may include obtaining values of function parameters included in the set of function parameters. The values of function parameters may be associated with an individual content creator by virtue of characterizing interaction with and/or quality of content generated by the individual content creator. Operation 208 may be performed by one or more hardware processors configured by machine-readable instructions including a component that is the same as or similar to reward determination component 112, in accordance with one or more implementations.

An operation 210 may include determining a reward to be awarded to the individual content creator, responsive to obtaining the values of the function parameters. Determining the reward may include evaluating the individual reward distribution function in accordance with the values of the function parameters included in the set of function parameters to determine an amount of rewards. The reward may be determined in accordance with the amount of rewards. Operation 210 may be performed by one or more hardware processors configured by machine-readable instructions including a component that is the same as or similar to reward determination component 112, in accordance with one or more implementations.

An operation 212 may include effectuating delivery of the reward to the individual content creator. Operation 212 may be performed by one or more hardware processors configured by machine-readable instructions including a component that is the same as or similar to reward delivery component 114, in accordance with one or more implementations.

An operation 214 may include updating the function view on the client computing platform to convey the delivery of the reward responsive to delivery of the reward. Operation 214 may be performed by one or more hardware processors configured by machine-readable instructions including a component that is the same as or similar to reward delivery component 114, in accordance with one or more implementations.

In some implementations, method 203 (shown in FIG. 2B) may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 203 in response to instructions stored electronically on an electronic storage medium. The one or more processing devices may include one or more devices configured through hardware, firmware, and/or software to be specifically designed for execution of one or more of the operations of method 203. FIG. 2B illustrates method 203, in accordance with one or more implementations. In some implementations, the operations of method 203 may be performed after and/or responsive to the operations of method 200 (shown in FIG. 2A).

An operation 216 may include obtaining historical reward information. Operation 216 may be performed by one or more hardware processors configured by machine-readable instructions including a component that is the same as or similar to reward history component 116, in accordance with one or more implementations.

An operation 218 may include determining a maximum cumulative amount and/or value of rewards awarded to one or more content creators over a given period of time has been approached and/or reached. In some implementations, determining the maximum cumulative amount and/or value has been approached and/or reached is done in accordance with the historical reward information. Operation 218 may be performed by one or more hardware processors configured by machine-readable instructions including a component that is the same as or similar to reward history component 116, in accordance with one or more implementations.

An operation 220 may include updating the individual reward distribution function included in the individual client record. In some implementations, the values and/or amounts of rewards determined using the individual reward distribution function may be lowered. Operation 220 may be performed by one or more hardware processors configured by machine-readable instructions including a component that is the same as or similar to function updating component 110, in accordance with one or more implementations.

In some implementations, method 205 (shown in FIG. 2C) may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 205 in response to instructions stored electronically on an electronic storage medium. The one or more processing devices may include one or more devices configured through hardware, firmware, and/or software to be specifically designed for execution of one or more of the operations of method 205. FIG. 2C illustrates method 205, in accordance with one or more implementations. In some implementations, the operations of method 205 may be performed after and/or responsive to the operations of method 200 (shown in FIG. 2A).

An operation 222 may include determining the individual content creator is eligible for a minimum reward, in accordance with the content creator activity information. Operation 222 may be performed by one or more hardware processors configured by machine-readable instructions including a component that is the same as or similar to reward determination component 112, in accordance with one or more implementations.

An operation 224 may include determining whether the reward is less than the minimum reward, responsive to determining the individual content creator is eligible for the minimum reward. Determining the reward is less than the minimum reward may include determining a value and/or an amount of the reward is less than a value and/or an amount of the minimum reward. Operation 224 may be performed by one or more hardware processors configured by machine-readable instructions including a component that is the same as or similar to reward determination component 112, in accordance with one or more implementations.

An operation 226 may include effectuating delivery of the minimum reward, responsive to determining the reward is less than the minimum reward. Operation 226 may be performed by one or more hardware processors configured by machine-readable instructions including a component that is the same as or similar to reward delivery component 114, in accordance with one or more implementations.

In some implementations, method 207 (shown in FIG. 2D) may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 207 in response to instructions stored electronically on an electronic storage medium. The one or more processing devices may include one or more devices configured through hardware, firmware, and/or software to be specifically designed for execution of one or more of the operations of method 207. FIG. 2D illustrates method 207, in accordance with one or more implementations. In some implementations, the operations of method 207 may be performed after and/or responsive to the operations of method 200 (shown in FIG. 2A). An operation 228 may include determining the individual content creator is eligible for one or more rewards not determined using the individual reward distribution function. In some implementations, determining the individual content creator eligible may be done in accordance with information included in the individual content creator record. Operation 228 may be performed by one or more hardware processors configured by machine-readable instructions including a component that is the same as or similar to reward determination component 112, in accordance with one or more implementations.

An operation 230 may include effectuating delivery of the one or more rewards, responsive to determining the individual content creator is eligible. Operation 230 may be performed by one or more hardware processors configured by machine-readable instructions including a component that is the same as or similar to reward delivery component 114, in accordance with one or more implementations.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to automating incentivization of themed content generated by consumer users and shared through social online platforms, the system comprising:
storage media that stores information organized into client records, wherein individual client records associated with individual clients, wherein individual client records include individual reward distribution functions, wherein individual reward distribution functions define amounts of rewards as functions of values of one or more function parameters, wherein function parameters characterize interaction with content and/or quality of content;
one or more hardware processors configured by machine-readable instructions to:
effectuate transmission of information included in an individual client record to a client computing platform to effectuate presentation of a function view within a user interface on the client computing platform, wherein the function view conveys a set of function parameters and exemplary rewards in accordance with an individual reward distribution function, wherein an individual reward distribution function included in the individual client record defines an amount of rewards as a function of values of function parameters included in the set of function parameters, wherein the exemplary rewards are determined using the individual reward distribution function in accordance with exemplary values of function parameters included in the set of function parameters, wherein the function view includes one or more fields that facilitate entry and/or selection of one or more adjustments to the individual reward distribution function;
receive entry and/or selection of the one or more adjustments to the individual reward distribution function;
update the individual reward distribution function included in the client record in accordance with the one or more adjustments to the individual reward distribution function;
obtain values of function parameters included in the set of function parameters, wherein the values of function parameters are associated with an individual content creator by virtue of characterizing interaction with and/or quality of content generated by the individual content creator;
determine, responsive to obtaining the values of the function parameters, a reward to be awarded to the individual content creator, wherein determining the reward includes evaluating the individual reward distribution function in accordance with the values of the function parameters included in the set of function parameters to determine an amount of rewards, wherein the reward is determined in accordance with the amount of rewards;
effectuate delivery of the reward to the individual content creator; and
update, responsive to delivery of the reward, the function view on the client computing platform to convey the delivery of the reward.

2. The system of claim 1, wherein obtaining values of function parameters included in the set of function parameters includes obtaining values of quality metrics.

3. The system of claim 2, wherein obtaining the quality metrics includes automatically analyzing content to generate the values of the quality metrics.

4. The system of claim 2, wherein the quality metrics include one or more of a timeframe of presence of an object and/or a person within the content, quality of framing of an object and/or person within the content, duration of the content, audio quality of the content, visual quality of the content, and/or similarity of the content to other content.

5. The system of claim 1, wherein the set of function parameters is generated in accordance with client entry and/or selection of one or more function parameters and/or in accordance with a default selection of one or more function parameters.

6. The system of claim 1, wherein the one or more adjustments to the individual reward distribution function include one or more adjustments to the set of function parameters and/or one or more adjustments to weighting of individual function parameters included in the set of function parameters, wherein an adjustment to the set of function parameters includes an addition of one or more function parameters to the set of function parameters and/or a removal of one or more function parameters from the set of function parameters, wherein weighting of an individual function parameter characterizes magnitude of importance of the individual function parameter for determining amounts of rewards using the individual reward distribution function.

7. The system of claim 1, wherein the individual reward distribution function is a nonlinear and/or discrete mathematical function.

8. The system of claim 1, wherein the set of function parameters include a maximum cumulative amount and/or cumulative value of rewards awarded to one or more content creators over a given period of time, wherein individual client records include historical reward information, wherein the historical reward information includes a cumulative amount and/or value of rewards awarded to one or more content creators over a given period of time, wherein the one or more hardware processors are configured to:
obtain historical reward information included in the individual client record;
determine, in accordance with the historical reward information, a maximum cumulative amount and/or value of rewards awarded to one or more content creators over a given period of time has been approached and/or reached; and
update the individual reward distribution function included in the individual client record such that the values and/or amounts of rewards determined using the individual reward distribution function are lowered.

9. The system of claim 1, wherein the set of function parameters include a minimum reward, wherein the one or more hardware processors are configured to:
determine, in accordance with the content creator activity information, the individual content creator is eligible for a minimum reward;
determine, responsive to determining the individual content creator is eligible for a minimum reward, the reward is less than the minimum reward, wherein determining the reward is less than the minimum reward includes determining a value and/or an amount of the reward is less than a value and/or an amount of the minimum reward; and
effectuate delivery of the minimum reward, responsive to determining the reward is less than the minimum reward.

10. The system of claim 1, wherein the one or more hardware processors are configured to:
determine, in accordance with information included in the individual content creator record, the individual content creator is eligible for one or more rewards not determined using the individual reward distribution function; and
effectuate delivery of the one or more rewards, responsive to determining the individual content creator is eligible.

11. A method of automating incentivization of themed content generated by consumer users and shared through social online platforms, the method including:
effectuating transmission of information included in an individual client record to a client computing platform to effectuate presentation of a function view within a user interface on the client computing platform, wherein the individual client record is associated with an individual client, wherein the individual client record includes an individual reward distribution function, wherein the individual reward distribution function defines an amount of rewards as a function of values of one or more function parameters, wherein function parameters characterize interaction with content and/or quality of content, wherein the function view conveys a set of function parameters and exemplary rewards in accordance with the individual reward distribution function, wherein the exemplary rewards are determined using the individual reward distribution function in accordance with exemplary values of function parameters included in the set of function parameters, wherein the function view includes one or more fields that facilitate entry and/or selection of one or more adjustments to the individual reward distribution function;
receiving entry and/or selection of the one or more adjustments to the individual reward distribution function;
updating the individual reward distribution function included in the client record in accordance with the one or more adjustments to the individual reward distribution function;
obtaining values of function parameters included in the set of function parameters, wherein the values of function parameters are associated with an individual content creator by virtue of characterizing interaction with and/or quality of content generated by the individual content creator;
determining, responsive to obtaining the values of the function parameters, a reward to be awarded to the individual content creator, wherein determining the reward includes evaluating the individual reward distribution function in accordance with the values of the function parameters included in the set of function parameters to determine an amount of rewards, wherein the reward is determined in accordance with the amount of rewards;
effectuating delivery of the reward to the individual content creator; and
updating, responsive to delivery of the reward, the function view on the client computing platform to convey the delivery of the reward.

12. The method of claim 11, wherein obtaining values of function parameters included in the set of function parameters includes obtaining values of quality metrics.

13. The method of claim 12, wherein obtaining the quality metrics includes automatically analyzing content to generate the values of the quality metrics.

14. The method of claim 13, wherein the quality metrics include one or more of a timeframe of presence of an object and/or a person within the content, quality of framing of an object and/or person within the content, duration of the content, audio quality of the content, visual quality of the content, and/or similarity of the content to other content.

15. The method of claim 11, wherein the set of function parameters is generated in accordance with client entry and/or selection of one or more function parameters and/or in accordance with a default selection of one or more function parameters.

16. The method of claim 11, wherein the one or more adjustments to the individual reward distribution function include one or more adjustments to the set of function parameters and/or one or more adjustments to weighting of individual function parameters included in the set of function parameters, wherein an adjustment to the set of function parameters includes an addition of one or more function parameters to the set of function parameters and/or a removal of one or more function parameters from the set of function parameters, wherein weighting of an individual function parameter characterizes magnitude of importance of the individual function parameter for determining amounts of rewards using the individual reward distribution function.

17. The method of claim 11, wherein the individual reward distribution function is a nonlinear and/or discrete mathematical function.

18. The method of claim 11, wherein the set of function parameters include a maximum cumulative amount and/or cumulative value of rewards awarded to one or more content creators over a given period of time, wherein individual client records include historical reward information, wherein the historical reward information includes a cumulative amount and/or value of rewards awarded to one or more content creators over a given period of time, wherein the method includes:
obtaining historical reward information included in the individual client record;
determining, in accordance with the historical reward information, a maximum cumulative amount and/or value of rewards awarded to one or more content creators over a given period of time has been approached and/or reached; and
updating the individual reward distribution function included in the individual client record such that the values and/or amounts of rewards determined using the individual reward distribution function are lowered.

19. The method of claim 11, wherein the set of function parameters include a minimum reward, wherein the method includes:
determining, in accordance with the content creator activity information, the individual content creator is eligible for a minimum reward;
determining, responsive to determining the individual content creator is eligible for a minimum reward, the reward is less than the minimum reward, wherein determining the reward is less than the minimum reward includes determining a value and/or an amount of the reward is less than a value and/or an amount of the minimum reward; and
effectuating delivery of the minimum reward, responsive to determining the reward is less than the minimum reward.

20. The method of claim 11, wherein the method includes:
determining, in accordance with information included in the individual content creator record, the individual content creator is eligible for one or more rewards not determined using the individual reward distribution function; and
effectuating delivery of the one or more rewards, responsive to determining the individual content creator is eligible.
